(19) United States
(12) Patent Application Publication
(10) Pub. No.: US 2018/0104125 A1
(43) Pub. Date: Apr. 19, 2018

(54) Upper Extremity Support Device

(71) Applicant: Maltana Australia Pty Ltd, Western Australia (AU)

(72) Inventors: Narelle VAHALA, Karrinyup (AU); Stephen BURTON, Croydon (AU)

(21) Appl. No.: 15/571,982

(22) PCT Filed: May 6, 2016
(86) PCT No.: PCT/AU2016/050330

§ 371 Date: Nov. 6, 2017

(30) Foreign Application Priority Data
May 6, 2015 (AU) 2015901621

(51) Int. Cl. A61G 13/12; A61G 5/12

(52) U.S. Cl. CPC A61G 13/124; A61G 7/075; A61G 5/121; A61G 5/125

(57) ABSTRACT

A device for supporting recovery of an injured upper extremity of a subject includes a support member and a retainer. The support member has an inclined surface for supporting at least a first portion of the injured upper extremity at an angle of elevation. The retainer is for immobilising at least a second portion of the injured upper extremity on the support member.

This application claims priority from Australian Provisional Patent Application No. 2015901621 filed on 6 May 2015, the contents of which are to be taken as incorporated herein by this reference.

### TECHNICAL FIELD

The present invention relates to devices for supporting upper extremities. It relates particularly but not exclusively to devices for use during recovery from arm or hand surgery by elevating and immobilising the arm.

### BACKGROUND OF INVENTION

Improved surgical techniques have developed in recent times for the repair of injuries to the upper extremity, including the shoulder, arm, forearm, wrist and hand, leading to a significant rise in the number of such surgeries conducted. In particular, surgeries to repair injuries to the fingers, hand and wrist have become more common. However, post-surgical recovery has not advanced greatly and venous pooling, swelling and inadequate support after surgery can have a negative impact on surgical outcomes. In some cases, patients require additional surgery to resolve complications during initial surgical recovery caused by lack of support provided to the injured upper extremity and use of recovery aids that are not intended for use with intricate hand or arm surgery.

The majority of patients undergoing recovery from hand or wrist surgery are provided with one or more pillows or support pads to support and elevate their injured body part and are instructed to restrain from moving the injured body part until they have recovered. Alternatively, patients with minor injuries or who are in later stages of recovery may position their injured body part (e.g. arm) in a stop-sling. Unfortunately, both of these modes of post-surgical recovery have a number of disadvantages in terms of their effectiveness in supporting the injured body part, amount of recovery time required and level of patient comfort.

Firstly, these modes are ineffective for supporting recovery of the injured upper extremity since there is usually little or no elevation leading to venous blood pooling in the affected limb. In cases where elevation is provided by one or more pillows, the level of elevation is insufficient to be effective in avoiding pooling of venous blood. This results in poor circulation of the patient's blood and increased swelling. Not only does this extend recovery time, it also exacerbates the pain and discomfort experienced by the patient.

Secondly, most existing supports such as pillows and support pads do not provide the capacity to restrain and immobilise the patient's injured upper extremity. The patient is expected to self-restrain and immobilise their limb by remaining still. Given the discomfort experienced by most people during surgical recovery, it is uncommon to see satisfactory patient compliance when immobilising the injured upper extremity on a support using self-control alone. It is also impractical to expect this since the patient is likely to move during sleep or re-position their upper extremity as a result of pain or discomfort. Inadequate immobilisation during recovery can result in re-injury requiring further surgery, increased pain and discomfort, and a lengthened recovery time.

Another disadvantage is that the pillows or support pads currently in use are typically unsecured and unstable. Accordingly, when the patient moves, either due to discomfort or in sleep, the pillows or support pads can also move such that the injured upper extremity may become unsupported. This again results in discomfort, higher risk of re-injury and increased recovery times. In addition, use of such supports for patients positioned in bed may also increase the level of discomfort because the pillows and/or support pads occupy a large portion of the bed, leaving less space for the patient to rest. This is particularly true of overweight or obese patients for whom complications during surgical recovery are already more likely.

Moreover, existing supports are often not sized appropriately or made of materials that are able to adequately support recovery of injured upper extremities. In particular, the current supports have not been purpose-designed to support delicate parts of the upper extremities, such as hands or fingers.

The discussion of the background to the invention included herein including reference to documents, acts, materials, devices, articles and the like is included to explain the context of the present invention. This is not to be taken as an admission or a suggestion that any of the material referred to was published, known or part of the common general knowledge in Australia or in any other country as at the priority date of any of the claims.

### SUMMARY OF INVENTION

Viewed from one aspect of the present invention, there is provided a device for supporting recovery of an injured upper extremity of a subject. The device includes a support member and a retainer. The support member has an inclined surface for supporting at least a first portion of the injured upper extremity at an angle of elevation. The retainer is for immobilising at least a second portion of the injured upper extremity on the support member.

Preferably, the angle of elevation is at least about 30 degrees. More preferably, the angle of elevation is between about 30 degrees and about 60 degrees. Even more preferably, the angle of elevation is about 60 degrees. Elevating the at least first injured portion at 60 degrees may be an optimal level for supporting recovery and providing comfort for the subject.

In some embodiments, the angle of elevation is substantially constant along a length of the support member. Alternatively, in other embodiments, the inclined surface may include various angles of elevation along its length. Preferably, the device is adjustable to vary the angle of elevation of the inclined surface. The device may further include an adjustment insert couplable with the support member to adjust the angle of elevation of the inclined surface.

It is also preferable that the inclined surface of the device includes a widened portion shaped to support the width of the fingers or hand of the subject. Additionally/alternatively, the inclined surface may include a contoured portion shaped to receive part of the fingers or hand of the subject. The widened portion and contoured portion of the inclined surface provide additional support for delicate regions of the anatomy, including the injured fingers or hand of the subject. At least part of the inclined surface may also be textured to aid in stabilising the at least first portion of the injured upper extremity thereon.

In some embodiments, the support member is cushioned for supporting at least the first portion of the injured upper extremity. The support member may include a structure configured to receive one or more cushioned inserts for supporting at least the first portion of the injured upper extremity. The structure may include a scaffold having openings for receiving the cushioned inserts to provide the cushioned support. Preferably, the support member is at least partly made of foam material to cushion the first supported portion of the injured upper extremity. Alternatively, the support member may include one or more support components of varying density to provide the cushioned support.

The support member, in some embodiments, is reversibly deformable to facilitate repeated use of the device. Additionally/alternatively, the support member may be at least partly inflatable.

The device may also be releasably securable to an object (e.g. a hospital bed or chair) to stabilise the device when in use. Preferably, the device includes at least one strap means for releasably securing it to the object. Additionally/alternatively, the support member may include at least one mounting contour configured to cooperate with an object (e.g. a hospital bed or chair) for also stabilising the device when in use.

In some embodiments, the device further includes a removable cover surrounding at least part of the support member. Preferably, the cover is disposable, and additionally/alternatively, the cover is washable and reusable.

The support member may also include a base portion with a surface for supporting at least a third portion of the injured upper extremity. The base portion may consist of a unitary piece or it may include two or more portions of deformable material selected with varying thickness for supporting recovery of the injured upper extremity depending on the subject's size. The base portion may also have a widened portion for stabilising the support member when in use.

In some embodiments, the support member may also include a stabilising portion to stabilise the device when in use by providing greater area for contact with the object used to stabilise the device.

In some embodiments, the device includes a support mat for stabilising the device when in use.

The device may be adapted for use with an injured upper extremity being the hand. Thus, the first portion may include the fingers or hand, and the second portion may include the wrist or forearm. The third portion may include the upper arm.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereto.

### BRIEF DESCRIPTION OF DRAWINGS

The invention will now be described in greater detail with reference to the accompanying drawings in which like features are represented by like numerals. It is to be understood that the embodiments shown are examples only and are not to be taken as limiting the scope of the invention as defined in the claims appended hereto.

FIG. 1 illustrates a device for supporting recovery of an injured upper extremity according to an embodiment of the invention, showing a support member with an inclined surface for elevating part of the upper extremity and a retainer for immobilising part of the upper extremity.

FIG. 2 illustrates an embodiment of the device with adjustment inserts couplable with the support member for supporting recovery of an injured upper extremity, wherein the angle of elevation is adjustable.

FIG. 3 illustrates a widened portion of the inclined surface of a device for supporting recovery of an injured upper extremity, according to another embodiment of the invention, wherein the widened portion is shaped to support the width of broad fingers or hand of a subject.

FIG. 4 illustrates a contoured portion of the inclined surface of a device for supporting recovery of an injured upper extremity, according to another embodiment of the invention, wherein the contoured portion is shaped to receive part of the fingers or hand of a subject.

FIG. 5 illustrates a device for supporting recovery of an injured upper extremity, according to another embodiment of the invention, wherein the device includes a support member having an inflatable portion for elevating and immobilising part of the upper extremity, a non-inflatable base portion for supporting an upper part of the injured upper extremity and a support mat for stabilising the device.

FIG. 6 illustrates a device for supporting recovery of an injured upper extremity, according to another embodiment of the invention, wherein the device includes straps to releasably secure the device to an object, a stabilising portion to stabilise the device when positioned on the object, and a base portion for supporting an upper part of the injured upper extremity.

FIG. 7 illustrates a flanged contour on a device for supporting recovery of an injured upper extremity, according to another embodiment of the invention, wherein the contour is configured to cooperate with an object for stabilising the device when in use.

FIG. 8 illustrates the device of FIG. 6 according to another embodiment of the invention, the device having a grooved contour configured to cooperate with an object for stabilising the device when in use.

FIG. 9 illustrates a device for supporting recovery of an injured upper extremity, according to another embodiment of the invention, demonstrating the device in use by a subject, wherein the device is stabilised by attachment to a hospital bed on which the subject is resting.

### DETAILED DESCRIPTION

Embodiments of the invention are discussed herein by reference to the drawings which are not to scale and are intended merely to assist with explanation of the invention. The device has particular utility in supporting post-surgical recovery of a subject who has undergone surgery to an injured upper extremity and more specifically, injured fingers, hand or wrist. However, use of the inventive device is not limited to this application. For example, the device may be used to support post-surgical recovery of a subject's injured forearm, elbow, upper arm or shoulder. Furthermore, the device may be used to support recovery of an injured part of the subject's arm in circumstances which do not involve surgery, e.g. when the injury does not require surgical intervention however for effective and rapid recovery requires that the subject's injured upper extremity is elevated and immobilised.

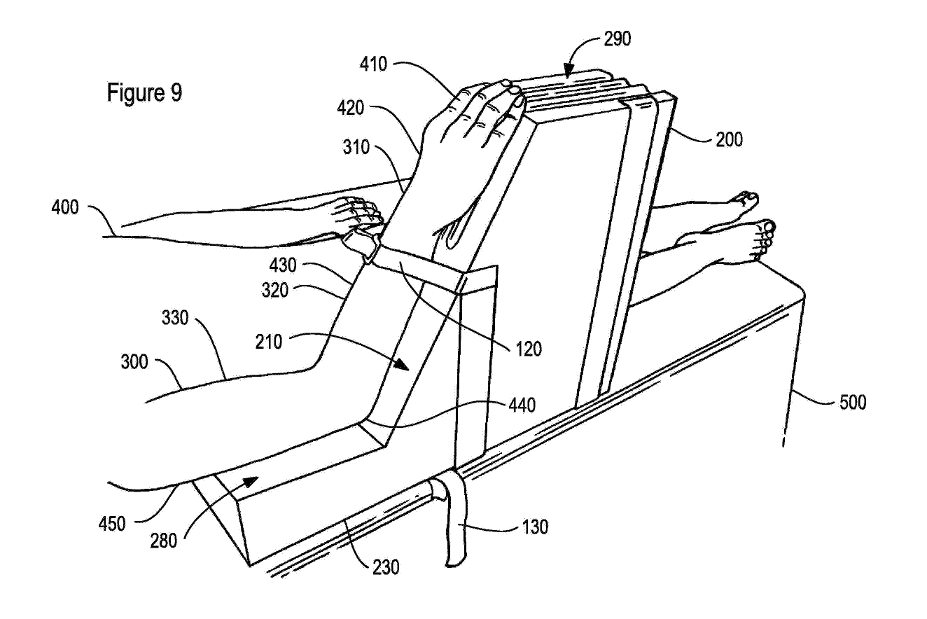

FIG. 1 shows a bolster device 100 for supporting recovery of an injured upper extremity 300 of a subject 400 (FIG. 9) according to an embodiment of the invention. The device 100 includes a support member 200 having an inclined surface 210 for supporting at least a first portion 310 of the injured upper extremity 300 at an angle of elevation 220. The device 100 also includes a retainer 120 for immobilising at least a second portion 320 of the injured upper extremity 300 on the support member 200. By providing an inclined surface 210 and a retainer 120, the device 100 supports recovery of the injured upper extremity 300 by elevating and immobilising it on the support member 200. Typically, the supported first portion 310 of the upper extremity 300 includes the parts of the arm that have been injured (and usually subjected to surgical intervention) and require elevation and immobilisation for optimal recovery. Meanwhile, the second portion 320 of the upper extremity 300 typically has not been injured or subjected to surgical intervention per se, and can be restrained in the manner described with minimal discomfort to the subject 400 and risk of interference with the surgical site. Typically, the first portion 310 includes the fingers and/or hand. The second portion 320 may include e.g. the forearm 430 and/or wrist.

Elevation of at least the first portion 310 of the injured upper extremity 300 is important to support recovery. However, existing supports, e.g. one or more pillows or support pads, usually provide little or no elevation of the injured upper extremity 300. It has not been recognised until now that sufficient elevation is required to avoid venous pooling in the affected limb, thereby circumventing problems of poor circulation of the subject's blood and increased swelling. Avoiding venous pooling is also beneficial to reduce the pain and discomfort suffered by the subject 400 during recovery. Therefore, elevation of at least the first portion 310 of the injured upper extremity 300 supports recovery by encouraging circulation of the subject's blood and reducing swelling, thereby avoiding lengthened recovery times.

The angle of elevation 220 of the inclined surface 210 may be at least about 10 degrees, about 20 degrees, about 30 degrees, about 40 degrees, about 50 degrees, about 60 degrees, about 70 degrees and about 80 degrees. Preferably, the angle of elevation 220 is at least about 20 degrees, but more preferably at least 30 degrees. An angle of elevation 220 of at least 20 degrees encourages adequate circulation of the subject's blood to substantially reduce venous pooling in the affected limb. However, an angle 220 of 30 degrees or greater promotes circulation such that venous pooling may be almost or completely avoided. Minimising venous pooling is beneficial to reduce swelling or throbbing in the affected limb of the subject 400, thereby improving the subject's comfort and promoting recovery of the injury. If the angle of elevation 220 is less than 20 degrees, this may be insufficient to avoid venous pooling and this gentle slope will not aid in the recovery process, as demonstrated by existing supports. A maximum angle of elevation 220 of 90 degrees can avoid venous pooling and promote circulation of the subject's blood. However, such large angles of elevation 220 are not desirable since this may increase the discomfort suffered by the subject 400 during recovery.

Accordingly, it is more preferable that the angle of elevation 220 is between about 30 degrees and about 60 degrees. This range of angles provides for improved blood circulation (avoiding venous pooling), while also providing an acceptable level of comfort. Even more preferably, the angle of elevation 220 is about 60 degrees, as illustrated in FIG. 1. This provides an optimal level of elevation of the first portion 310 of the injured upper extremity 300 and comfort for the subject 400.

FIG. 1 also shows that the inclined surface 210 includes a substantially constant angle of elevation 220 along its length. It is preferable to provide a substantially constant angle along this length since the first portion 310 of the subject's injured upper extremity 300 may be positioned with ease and comfort on the support member 200. Typically, the first portion 310 may include the subject's hand 420 and fingers 410 and the second portion 320 may include the forearm 430 and/or wrist which anatomy usually enjoys comfortable support on a flat surface when resting (see FIG. 9 of the device 100 in use). Accordingly, a substantially constant angle of elevation 220 along the inclined surface 210 is usually suitable.

Alternatively, the inclined surface 210 may include various angles of elevation 220 along its length (not shown). To achieve this, in some embodiments the inclined surface 210 includes curved or straight sections that have different angles of elevation. When the injured upper extremity 300 is positioned on the device 100, an undulating or varying angle support surface 210 may be suitable to provide different levels of support depending on the type and extent of injury to parts of the subject's upper extremity 300. A varying inclined surface 210 of this type may be preferable when both the subject's forearm 430 and hand 420 are injured, each benefiting from elevation and immobilisation but at different angles of support.

An advantage of the inventive device 100 is that the injured upper extremity 300 is elevated and immobilised in a manner that still allows for neuromuscular observations of the injured upper extremity 300 to be completed with greater access and visual acuity. This is because the first portion 310 (e.g. fingers and hand) of the injured upper extremity 300 is positioned on the inclined surface 210 at the angle of elevation 220, while the retainer 120 immobilises at least the second portion 320 (e.g. forearm) of the upper extremity 300. Applying the retainer 120 to the second portion 320 of the upper extremity 300 ensures that the first portion 310 remains visible for neurological and visual observation, and that the surgical site is not interfered with by the device 100. This is particularly useful when the first portion 310 includes the hand 420 or fingers 410 of the subject 400 (see FIG. 9).

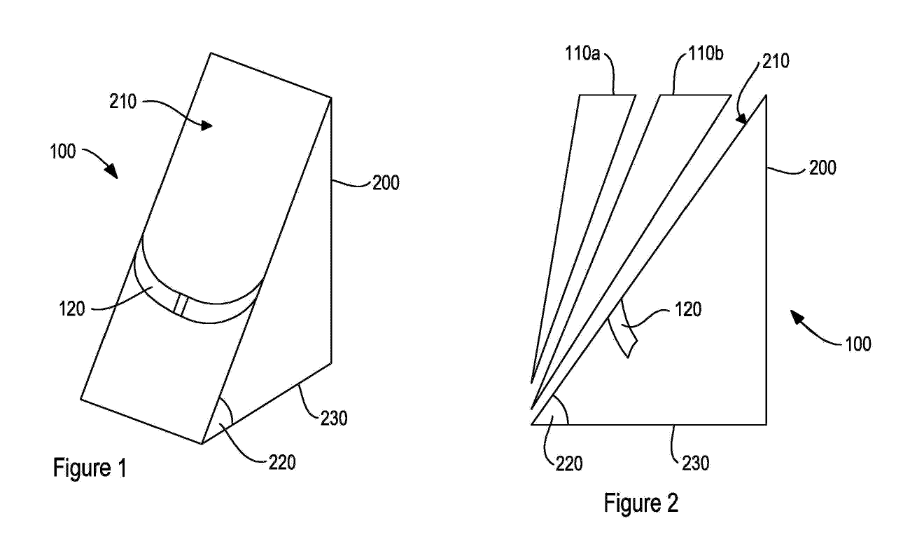

In some embodiments, the device 100 is adjustable to modify the angle of elevation 220 of at least the first portion 310 of the injured upper extremity 300. For example, the device 100 may further include an adjustment insert 110 couplable with the support member 200 to adjust the angle of elevation 220 of the inclined surface 210. FIG. 2 demonstrates an exploded view of one or more adjustment inserts 110a, 110b that may be coupled with the support member 200 to increase the angle of elevation 220. The adjustment inserts 110a, 110b may be coupled to the support member 200 by attachment means including Velcro straps, hook and loop fasteners, a notch and groove, friction coupling or clip and buckles to name a few.

Advantageously, a variable inclined surface 210, for example using adjustment inserts 110a, 110b, enables the device 100 to be adapted for use with subjects of different size and/or proportions and recovering from different types of surgeries. Thus, the device 100 may be used by a large number of subjects with a variety of clinical needs as may be the case in a hospital or other clinical setting. The angle of elevation 220 may be adjusted by removing and replacing an adjustment insert 110a, 110b with another adjustment insert 110b, 110a that provides a different angle of elevation 220 depending on the stage of recovery of the injured upper extremity 300 or e.g. during sleep. For example, in the case of post-surgical recovery of a hand injury, the subject 400 may be on a high level of pain medication and therefore tolerate a greater angle of elevation 220, perhaps to a large angle of say, 70 degrees. However, as the subject 400 recovers, this angle of elevation 220 may need to be reduced (by removal of one or more adjustment inserts 110a, 110b) in accordance with comfort requirements of the subject 400. In some embodiments, the device 100 may be manufactured to include a support member 200 with an angle of elevation 220 of 30 degrees, and removable adjustment inserts 110a, 110b having different widths and/or contributing to different angles of elevation.

Device 100 includes a retainer 120 for immobilising at least a second portion 320 of the injured upper extremity 300 on the support member 200. The embodiment of FIG. 1 shows retainer 120 positioned approximately one-third to mid-way along the length of the inclined surface 210. However, one or more retainers 120 may be positioned at any location on the support member 200. The retainer 120 may include at least one strap means for immobilising the at least second portion 320 of the injured upper extremity 300 on the support member 200. The at least one strap means may include straps that are fastenable with a clip and buckle, quick release straps, friction fit clasps or hook and loop fasteners to name a few. It is desirable that the second portion 320 of the injured upper extremity 300 being restrained is not severely injured so as to avoid re-injury or discomfort caused by pressure applied through retainer 120 while immobilising the arm.

Advantageously, the retainer 120 avoids the need for the subject 400 to self-restrain and immobilise their injured limb 300 on the support member 200 improving upon existing supports which, in the absence of a retainer 120, give rise to unsatisfactory patient compliance in immobilising the injured upper extremity 300 during recovery. By ensuring sufficient immobilisation of the injured upper extremity 300, the device 100 of the present invention optimises recovery and mitigates the risk of re-injury through the subject 400 removing their injured upper extremity 300 from the support member 200.

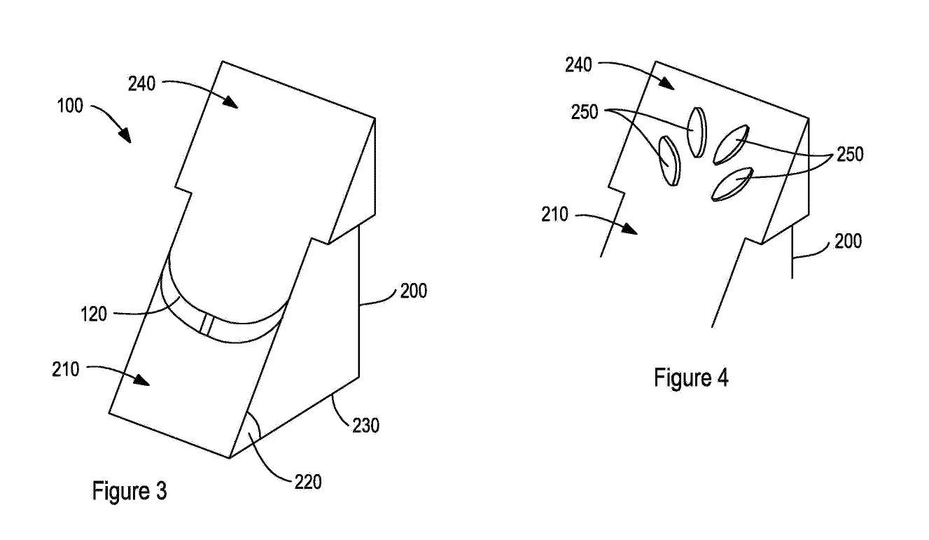

In some embodiments, the inclined surface 210 includes a portion 240 shaped to support the fingers 410 or hand 420 of the subject 400 (see also FIG. 9). FIG. 3 shows the shaped portion 240 as a widened portion toward the top of the inclined surface 210 of the support member 200. In cases where the first portion 310 of the injured upper extremity includes the fingers 410 or hand 420, the widened portion 240 provides further support to these delicate regions. This is particularly useful for cases requiring the fingers 410 to be separated during recovery, while the subject 400 supports their hand 420 on surface 210. The widened portion 240 is shaped to ensure that the fingers 410 or hand 420 remain fully supported on the inclined surface 210 during recovery and may be particularly important for subjects with large and/or broad hands and fingers.

Additionally/alternatively, the inclined surface 210 may include a contoured portion 250 shaped to support the individual fingers 410 or shape of the hand 420 of the subject 400. FIG. 4 shows, in one embodiment, that the contoured portion 250 may include shallow ruts 250 which are shaped to accommodate the fingers 410 of the subject's hand 420. The ruts not only provide comfort to the fingers 410 or hand 420 but also maintain separation of the injured digits of the subject's hand 420 which may promote recovery and enhance comfort. In some embodiments, ruts 250 may be replaced e.g. by raised support wedges, which are shaped to separate and support the fingers 410.

In some embodiments, at least part of the inclined surface 210 may be textured (not shown) to aid in stabilising at least the first portion 310 of the injured upper extremity 300 thereon. For example, the inclined surface 210 may include raised portions, a roughened surface, textured dots, grooves or channels. These textured portions of the inclined surface 210 may operate on a frictional basis to prevent sliding and/or slippage of at least the first portion 310 off the inclined surface 210. In some embodiments, the inclined surface 210 may include grooves or channels shaped to the anatomy or proportions of the first portion 310 of the injured upper extremity 300 such that at least the first portion 310 is situated in the grooves or channels when the device 100 is in use. Beneficially, this further immobilises and stabilises the first portion 310 on the support member 200, in addition to the retainer 120 immobilising the at least second portion 320.

In some embodiments, the support member 200 is cushioned or at least somewhat compressible for comfortably supporting at least the first portion 310 of the injured upper extremity 300. The support member 200 may be made of a substantially deformable material in order to provide such cushioning. Preferably, the support member 200 is made of a solid foam or spongy material, of a density and stiffness that deforms while providing comfortable support when the first portion 310 is supported by the device 100. For example, the support member 200 may be made of memory foam. Ideally, the support member 200 is reversibly deformable to facilitate repeated use of the device 100 either with the same subject 400, or with different subjects.

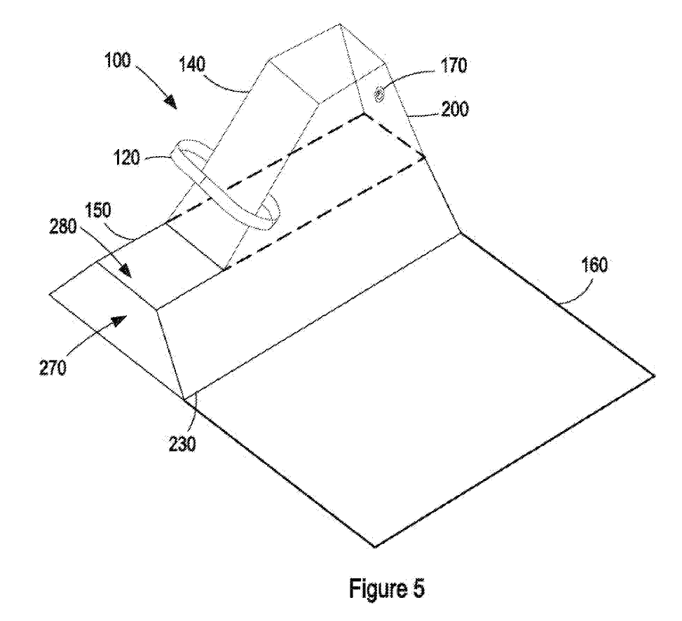

Alternatively, the support member 200 (or part thereof) may be inflatable (e.g. with air, carbon dioxide) and provide cushioned support for the at least first portion 310 elevated on the inclined surface 210 based on the fluid pressure of the inflated support member 200. By altering the fluid pressure within the support member 200, the level of cushioning provided to the first portion 310 may be adjusted depending on the subject's requirements. FIG. 5 illustrates that the support member 200 may include two portions, a first portion 140 which is inflatable and cushionable to support the at least first portion 310 of the injured upper extremity 300 on the inclined surface 210, and a second portion 150 which is made of a substantially deformable material, such as a solid foam or spongy material. The first portion 140 includes a fluid inflation inlet 170 with a valve for inflating the first portion 140 e.g. with air, carbon dioxide or other suitable fluid. In alternative embodiments, the second portion 150 may include the fluid inflation inlet 170 with the valve and include tubing that communicates with the inlet 170 and a port of the inflatable first portion 140 (not shown). It may be desirable to include the fluid inflation inlet 170 in the second portion 150 such that the valve is not inadvertently opened due to the weight of the subject's injured upper extremity 300 on the inflatable first portion 140 of the support member 200.

The second portion 150 may support a third portion 330 of the injured upper extremity 300 and provide stability to the support member 200. In some embodiments, the second portion 150 includes a base portion 270 with a surface 280 for supporting a third portion 330 of the injured upper extremity 300, as shown in FIG. 5. Base portion 270 may include a number of layers of deformable material, e.g. foam, with appropriate thicknesses to adequately support recovery of the injured upper extremity 300 depending on the subject's size (not shown). Preferably, base portion 270 includes two or three layers of foam with varying thickness for support. The foam layers in the base portion 270 desirably provide comfort to the subject 400 and assist in preventing areas of focussed pressure on the elbow 440 and upper arm 450 of the subject 400 (FIG. 9). Furthermore, base portion 270 may be releasably attached to the inflatable first portion 140 by straps or other fasteners, or held together by a removable cover which may be disposable or washable/reusable (not shown).

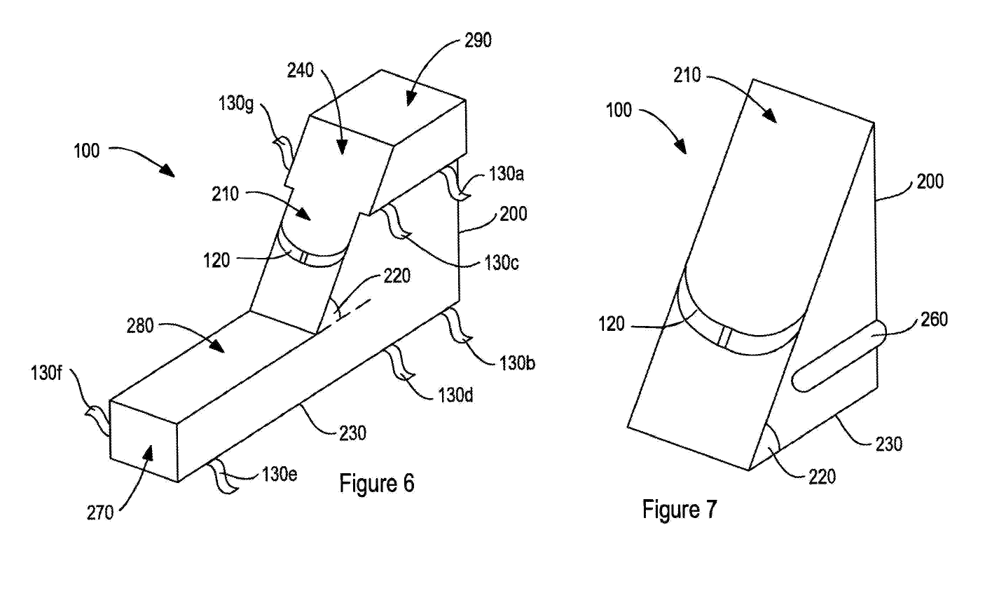

The base portion 270 is illustrated in FIG. 5 as an extension in the shape of a trapezoidal prism at the base 230 of the inflatable support member 200. The base portion 270 has a substantially flat surface 280 for supporting the third portion 330 of the injured upper extremity 300 and a wider portion at base 230 due to the trapezoidal cross-section. However, the extension is not limited to the shape of a trapezoidal prism and may be of any shape that provides a widened portion at base 230 of the device 100. The widened portion enhances the stability of the inflatable device 100 by providing a greater area for contact with an object 500 on which the inflatable device 100 is positioned, such as a hospital bed. This is particularly useful for inflatable devices 100 which do not include strap means 130, as shown in FIG. 6, which enable the device 100 to be secured to an object 500 for stability. FIG. 5 also shows that the inflatable first portion 140 is similarly shaped and includes sloping side panels that desirably enhance usability and minimise sharp edges, which may be problematic during inflation.

In some embodiments, the support member 200 may include a structure (not shown) that is configured to receive one or more cushioned inserts to support at least the elevated first portion 310 of the injured upper extremity 300. The structure may include a scaffold having openings extending partly or entirely therethrough for receiving the cushioned inserts. Advantageously, the structure may be fabricated such that the dimensions of the scaffold and openings are optimised for supporting recovery of the injured upper extremity 300 depending on the subject's anatomy. To achieve this, the structure may be fabricated through 3D printing techniques and include a plastic material. The dimensions of the structure may desirably be individualised to match the subject's anatomy. The cushioned inserts may include deformable material such as foam for providing cushioned support. The level of support may be varied by altering the number of cushioned inserts or their position in openings of the scaffold. Additionally/alternatively, the cushioned inserts may include material of varying density and stiffness such that cushioned inserts may be selected for use with the structure depending on the level of support required.

Alternatively, the support member 200 may omit the structure and instead include one or more support components (not shown) for supporting at least the elevated first portion 310 of the injured upper extremity 300. The support components may include a plastic material and be fabricated as solid or hollow components. The density of the support components may be altered to vary the level of support provided and in some embodiments, the support components may be inflatable e.g. with air. Beneficially, this eliminates the use of cushioned foam inserts and provides for ease of manufacturability. The support components may be fabricated through 3D printing techniques, or alternatively, computer numerical control (CNC) techniques. The support components may also be releasably attachable to one another through grooves and respective projections formed in the components, or through other means, such as Velcro straps and the like. Further, the support components may be fabricated with flanges or grooves for ease of engagement with an object, e.g. a hospital bed or rail thereof, for providing stability to the support member 200.

Preferably, the material of the support member 200 is pre-treated to include a coating that inhibits the ingress of liquids, e.g. blood or fluids from the subject's injured upper extremity 300, therapeutic agents, and the growth of bacteria or mould. The coating is desirable to minimise the risk of infection during recovery and/or transmission of bacteria between subjects when the device 100 is re-usable.

Furthermore, in some embodiments, the device 100 includes a removable cover surrounding at least part of the support member 200 (not shown). In some embodiments, the removable cover may be easily cleanable and able to be sanitised. The removable cover may be made of vinyl, or specialised material suitable for use in health care, such as in hospitals. In some embodiments, the cover is removable so that it is able to be cleaned. Thus, the cover may include a zip or other fastener on a rear or bottom surface of the device 100 not used to support the subject 400, such as base 230 of the support member 200. Additionally/alternatively, the removable cover made be made of a single piece of material such that when the device 100 is in contact with the subject's injured upper extremity 300, blood or fluids of the subject 400 may be easily cleaned from the cover without penetrating sewn seams. In some embodiments, the cover is washable and reusable. In other embodiments, the cover is disposable and intended only for single use.

In some embodiments, the device 100 may include a support mat 160 as shown in FIG. 5, which is releasably securable to the support member 200 to stabilise the device 100 when in use. The support mat 160 may be sized and shaped such that when the device 100 is in use, the subject 400 may be lying on the support mat 160 with their injured upper extremity 300 supported on the support member 200. The support member 200 may be releasably securable to the support mat 160 by the device 100 including at least one strap means 130, as described previously in other embodiments. Preferably, the support member 200 includes at least one Velcro strap on its base 230 which is attachable to the support mat 160. Alternatively, the support mat 160 may include the at least one Velcro strap attachable to the base 230 of the support member 200 although other detachable fastening means between the support mat 160 and the support member 200 are contemplated. When the subject 400 is lying on the support mat 160, the device 100 is stabilised by securing the support member 200 to the support mat 160 by the fastening means (e.g. one or more Velcro straps) and by anchoring the support mat 160 in place under the body weight of the subject 400.

The support mat 160 is particularly useful in embodiments where the support member 200 is used in the home or other environment where hospital bed rails are not available for attachment and stabilisation of the support member 200. The support mat 160 may be useful with inflatable embodiments of the support member 200 as shown in FIG. 1. The support mat 160 itself may also be inflatable such that it is more fluidly movable and/or compressible when in use by the subject 400 than in the non-inflatable embodiments. The base 230 of the inflatable support member 200 may be releasably attachable or permanently fixed to the support mat 160 as shown in FIG. 5. Advantageously, the inflatable embodiments encourage a subject 400 to use the device 100 at home or other facility to continue supporting their injured upper extremity 300 post-surgery due to its portability and adjustability with respect to elevation and comfort.

However, the support mat 160 is not limited to use with inflatable support members 200. The support mat 160 may also be cushioned or at least somewhat compressible for comfortably supporting the subject 400. The support mat 160 may have similar features to the support member 200 as described, such as being reversibly deformable or made of memory foam. Alternatively, the support mat 160 may be made of a fabric or plastic sheet. The support mat 160 may further include a removable cover, which is reusable and washable, with similar features to the removable cover of support member 200. The support mat 160 may be releasably securable to the support member 200 in either the left or right-hand configurations so that the device 100 may be used for supporting recovery of left or right-arm upper extremity injuries. This may require rotation of the support mat 160 through 180 degrees. Alternatively, fastening means (such as one or more Velcro straps) may be provided on both sides of the support mat 160 to render it useful for supporting recovery of the left or right arm upper extremity injuries.

Ideally, the device 100 is releasably securable to an object 500 to stabilise the device 100 when in use (FIG. 9). The object 500 may include a bed, a chair, a rail or a support, and is typically a hospital or surgical bed with rails. In order to releasably secure the device 100 to an object 500, the device 100 may further include at least one strap means 130. FIG. 6 depicts an embodiment of the device 100 which includes strap means 130 in pairs 130a and 130b, and 130c and 130d. These strap pairs may include a clip and buckle or other fasteners to releasably secure the device 100 to the object 500. Alternatively, straps 130e, 130f and 130g may be used to secure the device 100 to the object 500 either by attaching in pairs e.g. around or through a bed rail, or by direct attachment to the bed (FIG. 9). Straps may be included on one or both sides of the device 100. By including straps on both sides of the device 100, the device 100 can be used in a left or right-handed configuration for support of left or right upper extremity injuries.

Additionally/alternatively, the device 100 may be mounted on a rail of a hospital bed (not shown) thereby removing the device 100 from the bed space. Advantageously, this optimises the space to accommodate the subject 400. The straps 130a to 130d may be engaged by a buckle or other fastener to secure device 100 to a rail of the hospital bed. In contrast to existing supports which occupy a large portion of the bed, leaving less space for the subject 400 to rest comfortably, embodiments of the device 100 of the present invention which are mountable to a bed rail advantageously provide greater space for the subject 400 to recover, thereby improving comfort during recovery. This is particularly desirable for overweight or obese subjects who already have a higher risk of complications after surgery.

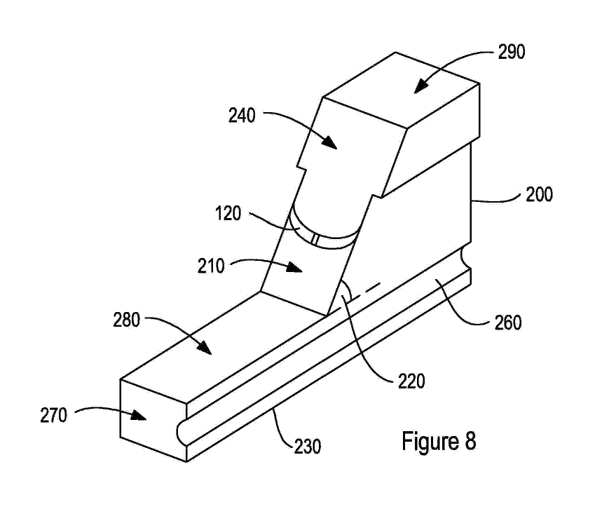

In some embodiments, the support member 200 may further include at least one mounting contour 260 configured to cooperate with an object 500 for stabilising the device 100 when in use. Examples of mounting contours are shown in FIGS. 7 and 8. FIG. 7 demonstrates a mounting contour 260 in the form of a flange that protrudes from a side wall of the support member 200. The flange may be configured to cooperate with the object 500 e.g. a bed rail by resting on the bed rail or by providing a “c-shaped” mounting contour (not shown) that receives part of the bed rail ideally in a friction fit. Additionally/alternatively, the at least one mounting contour 260 may include a groove as shown in FIG. 8. The groove may be configured to cooperate with e.g. a bed rail. Ideally, straps 130 are provided (although not shown) together with the mounting contour 260 to stabilise the device 100. The depictions and description of the mounting contours 260 in each of FIGS. 7 and 8 are configured to cooperate with an object 500 such as a hospital bed rail. However, object 500 may alternatively comprise a bed, a chair, a rail or a support of another kind.

The support member 200 may include a base portion 270 with a surface 280 for supporting at least a third portion 330 of the injured upper extremity 300 (FIGS. 5, 6, 8 and 9). The base portion 270 is illustrated in FIGS. 6, 8 and 9 as a rectangular extension at the base 230 of the support member 200. However, the extension need not be a rectangular shape and may instead be in the shape of a trapezoidal prism as shown in FIG. 5. Preferably, the surface 280 of the base portion 270 elevates the third portion 330 of the injured upper extremity 300 relative to the body of the subject 400 but in a non-inclined manner. For example, a subject 400 may have an injured hand 420, corresponding to the elevated first portion 310, an immobilised forearm 430, corresponding to the second portion 320, and an upper arm 450 corresponding to the third portion 330 which is elevated and supported on surface 280 without incline. Elevating the third portion 330 (upper arm) on the base portion 270 may be more comfortable for the subject 400 and may assist in promoting circulation of the subject's blood. Base portion 270 also stabilises the device 100 when in use by a subject 400 by providing greater area for contact with an object 500 on which the device 100 is positioned (see also FIG. 9). In some embodiments, the base portion 270 includes a widened portion for stabilising the support member when in use (FIG. 5), which is formed due to the shape of the extension. The widened portion enhances the stability of the device 100 by providing greater area for base 230 of the device 100 to contact with an object 500 on which it is positioned.

Furthermore, the embodiments illustrated in FIGS. 5, 6, 8 and 9 also provide a stabilising portion 290, which extends the long dimension of the support member 200 distally of the subject 400 when in use. Like base portion 270, stabilising portion 290 assists to stabilise the device 100 when in use by providing greater area for contact with an object 500 on which the device 100 is positioned. In some embodiments, the stabilising portion 290 may include at its upper end a widened portion 240, as shown in FIGS. 5, 6 and 8.

FIG. 9 illustrates device 100 in use by a subject 400 for supporting an injured upper extremity 300. In this embodiment, the device 100 includes support member 200 having an inclined surface 210 at an angle of elevation 220 of about 60 degrees. The first portion 310 of the injured upper extremity 300 includes the hand 420 and fingers 410. The device 100 includes a retainer 120 shown as a strap which secures the second portion 320 of the upper extremity, namely the forearm 430 and in particular the wrist, onto the support member 200. The device 100 also includes at least one strap means 130 depicted as a single strap which is directly attached to a hospital bed 500 on which the subject 400 is resting. Further, the support member 200 includes base portion 270 with a surface 280 supporting third portion 330, being the upper arm 450 of the injured upper extremity 300. The elbow 440 rests in the corner formed between the base surface 280 and inclined surface 210. When in use, the device 100 is secured to the hospital bed 500 by strap 130 and is stabilised by stabilising portion 290 of the device 100, which together with base portion 270, increases the area of contact with the hospital bed 500.

In use of the device 100, the elbow 440 of the subject 400 is stabilised and supported in the corner formed between the base surface 280 and the inclined surface 210, as shown in FIG. 9. Advantageously, providing support to the elbow 440 in this manner distributes the weight of the arm on the support device 100 and avoids excess pressure being applied to the elbow 440 itself, and thereby reduces the likelihood of compression of the ulnar nerve and resulting numbness of the injured hand 420 and immobilised forearm 430. Support of the elbow 440 at the angle of elevation 220 also provides comfortable positioning of the subject's shoulder with respect to the torso, as can also be observed in FIG. 9. This beneficially reduces the risk of injury to the shoulder when device 100 is in use.

To aid in the subject's comfort and reduction of shoulder injuries, device 100 is preferably used by a subject 400 who is positioned in the hospital bed 500 (or alternative seating support) such that their positioning is not substantially prone or lying flat. Ideally, the subject's torso is raised, typically by cushioning the upper back and neck with pillows. Advantageously, this avoids raising the upper arm 450 of the subject 400 with respect to their chest when positioning the upper arm 450 on the device 100. By maintaining the upper arm 450 at the same level as the chest, this reduces stress on the shoulder and thereby mitigates the risk of shoulder injuries while providing improved comfort to the subject 400.

Advantageously, the inventive device supports recovery by providing elevation of the injured upper extremity at a desirable angle such that venous pooling is reduced or avoided and circulation of the subject's blood is promoted. The device further supports recovery by immobilising the injured upper extremity on the device to overcome issues of patient non-compliance with prior art supporting devices. Furthermore, the inventive device is appropriately cushioned, sized and shaped to optimally support recovery of injured upper extremities, particularly hands and fingers. Additionally, the inventive device supports recovery of either the right or left upper extremity, and is safe to use. Stability of the device is particularly enhanced when secured to an object such as a hospital bed or bed rail, and when the long dimension of the support member is extended to increase contact with the bed or bed rail.

Use of the inventive device can reduce recovery time of an injured upper extremity by providing improved circulation, effective immobilisation and reducing pain and discomfort of the subject.

It is to be understood that various modifications, additions and/or alterations may be made to the parts previously described without departing from the ambit of the present invention as defined in the claims appended hereto.

It is to be understood that the following claims are provided by way of example only, and are not intended to limit the scope of what may be claimed in any future application. Features may be added to or omitted from the claims at a later date so as to further define or re-define the invention or inventions.

1. A device for supporting recovery of an injured upper extremity of a subject, the device including:
a support member having an inclined surface for supporting at least a first portion of the injured upper extremity at an angle of elevation; and
a retainer for immobilizing at least a second portion of the injured upper extremity on the support member.

2. The device according to claim 1, wherein the angle of elevation is at least about 30 degrees.

3. The device according to claim 1, wherein the angle of elevation is between about 30 degrees and about 60 degrees.

4. (canceled)

5. The device according to claim 1, wherein the angle of elevation is substantially constant along a length of the support member.

6. The device according to claim 1, wherein the inclined surface includes one or more of:
a widened portion shaped to support the width of the fingers or hand of the subject;
a contoured portion shaped to receive part of the fingers or hand of the subject; and
a textured surface to aid in stabilizing the at least first portion of the injured upper extremity thereon.

7. (canceled)

8. (canceled)

9. The device according to claim 1, wherein the device is adjustable to vary the angle of elevation of the inclined surface.

10. The device according to claim 9, the device further including an adjustment insert couplable with the support member to adjust the angle of elevation of the inclined surface.

11. The device according to claim 1, wherein the support member is one or both of:
cushioned for supporting at least the first portion of the injured upper extremity;
and
reversibly deformable to facilitate repeated use of the device.

12. The device according to claim 11, wherein the support member includes one of:
a structure configured to receive one or more cushioned inserts for supporting at least the first portion of the injured upper extremity; or
one or more support components of varying density to provide the cushioned support.

13. The device according to claim 12, wherein the structure is a scaffold having openings for receiving the cushioned inserts to provide the cushioned support.

14. The device according to claim 1, wherein the support member is one or both of:
at least partly made of foam material; and
at least partly inflatable.

15. (canceled)

16. (canceled)

17. The device according to claim 1, wherein the device is releasably securable to an object to stabilize the device when in use.

18. The device according to claim 17, the device further including at least one strap for releasably securing the device to the object.

19. The device according to claim 1, wherein the support member includes at least one mounting contour configured to cooperate with an object for stabilizing the device when in use.

20. The device according to claim 1, the device further including a removable cover surrounding at least part of the support member.

21. The device according to claim 20, wherein the cover is one or both of:
disposable; and
washable and reusable.

22. (canceled)

23. The device according to claim 1, wherein the support member includes a base portion with a surface for supporting at least a third portion of the injured upper extremity.

24. The device according to claim 23, wherein the base portion includes one or both of:
two or more of layers of deformable material selected with varying thickness for supporting recovery of the injured upper extremity depending on the subject's size; and
a widened portion for stabilizing the support member when in use.

25. (canceled)

26. (canceled)

27. The device according to claim 1, including a support mat for stabilizing the device when in use.

28. The device according to claim 1, wherein the device is adapted for use with an injured upper extremity being the hand, and wherein the first portion includes the fingers or hand, and the second portion includes the wrist or forearm.
